(19) United States
(12) Patent Application Publication
(10) Pub. No.: US 2010/0208065 A1
(43) Pub. Date: Aug. 19, 2010

(54) DEVICE FOR PRESENTING VISUAL INFORMATION

(75) Inventors: Andreas Heiner, Espoo (FI); Seamus Maloney, Riihimaki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/598,872

(22) PCT Filed: May 7, 2007
(86) PCT No.: PCT/FI07/00121

§ 371 Date: Apr. 27, 2010

(51) Int. Cl. H04N 7/18; G08B 5/24; G08B 23/00

(52) U.S. Cl. 348/143; 340/815.86; 340/573.1; 348/E07.091

(57) ABSTRACT

The invention relates to an arrangement and a method for presenting visual information. The arrangement comprises a direction detector (101) arranged to detect a direction in which an observer is situated in the surroundings of the arrangement and a display unit (104) arranged to present visual information responsive to a direction detection result produced with the direction detector. The arrangement can be used, for example, in an advertising kiosk for drawing attention of passers-by and in a desktop communication device for presenting visual information to a user and other people that may change their positions in the surroundings of the desktop communication device.

### FIELD OF THE INVENTION

The invention relates to a device for presenting visual information. The invention further relates to a method and an arrangement for presenting visual information.

### BACKGROUND

Examples of devices that present visual information are a desktop communication device that is provided with a display element and an advertising kiosk the purpose of which is to draw attention of passers-by. Known advertising kiosks show static pictures and texts, changing pictures and texts, and/or moving pictures and text. The ability of an advertising kiosk of the kind described above to draw attention of people is, however, quite limited. Making an advertising kiosk to be responsive to control actions given by a person who is looking at the advertising kiosk does not help much, because the advertising kiosk has to draw the attention of the person before being able to get any control actions from the said person. As another example, a known desktop communication device may have a display element the operation of which is responsive to intentional control actions given by a user of the communication device and/or control actions received from an electrical communication channel to which the communication device is connected. A need for the intentional control actions limits the freedom of action of the user and may even disturb the ability of the user to focus on the communication itself that is, however, the ultimate purpose of the action.

Typical devices according to the prior art for presenting visual information are arranged to operate according to a pre-determined schedule and/or according to intentional control actions given by a person in the vicinity of the device or received from an electrical communication channel. The above-presented examples indicate, however, that a typical technical solution according to the prior art for presenting visual information does not provide a satisfactory result in all applications.

### SUMMARY

In accordance with a first aspect of the invention a novel device for presenting visual information is provided. The device comprises:
a direction detector arranged to find a direction in which a potential observer is situated in the surroundings of the direction detector and to generate a direction detection result that is an indicator of said direction in which the potential observer is situated, and
a display unit capable of showing the visual information towards different directions in at least one of the following forms: a graphical form and a written form,
   wherein the display unit is arranged to show the visual information towards a direction that corresponds with the direction detection result and to change the direction towards which the visual information is shown as a response to a situation in which the direction detection result is changing.

The device according to an embodiment of the invention can be, for example, an advertising kiosk or a desktop communication device.

In accordance with a second aspect of the invention a novel arrangement for presenting visual information is provided. The arrangement comprises:
a direction detector arranged to find a direction in which a potential observer is situated in the surroundings of the direction detector and to generate a direction detection result that is an indicator of said direction in which the potential observer is situated, and
a display unit capable of showing the visual information towards different directions in at least one of the following forms: a graphical form and a written form,
   wherein the display unit is arranged to show the visual information towards a direction that corresponds with the direction detection result and to change the direction towards which the visual information is shown as a response to a situation in which the direction detection result is changing.

The arrangement according to an embodiment of the invention can be, for example, a part of an advertising kiosk or a part of a desktop communication device.

In accordance with a third aspect of the invention a novel method for presenting visual information is provided. The method comprises:
generating a direction detection result by finding a direction in which a potential observer is situated in the surroundings of a direction detector,
showing the visual information towards a direction that corresponds with the direction detection result, the visual information being shown in at least one of the following forms: a graphical form and a written form, and
changing the direction towards which the visual information is shown as a response to a situation in which the direction detection result is changing.

In accordance with a fourth aspect of the invention a novel computer program product embodied in a computer readable medium for presenting visual information is provided. The computer program product comprises:
computer program means for making a direction detector to find a direction in which a potential observer is situated in the surroundings of the direction detector and to generate a direction detection result that is an indicator of said direction in which the potential observer is situated, and
computer program means for making a display unit to show the visual information towards a direction that corresponds with the direction detection result and to change the direction towards which the visual information is shown as a response to a situation in which the direction detection result is changing, the visual information being shown in at least one of the following forms: a graphical form and a written form.

A number of embodiments of the invention are described in accompanied dependent claims.

The embodiments of the invention provide for example the following benefits:
An advertising kiosk can be made more capable of drawing attention of passers-by providing the advertising kiosk with an arrangement according to an embodiment of the invention for presenting visual information.
Usability of a desktop communication device can be improved by providing the desktop communication device with an arrangement according to an embodiment of the invention for presenting visual information. The desktop communication device can be arranged to present desired visual information to a user of the desktop communication device without a need for intentional control actions of the user also in a situation in which the user is moving around the desktop communication device.

Various embodiments of the invention both as to constructions and to methods of operation, together with additional objects and advantages thereof, will be best understood from the following description of specific embodiments when read in connection with the accompanying drawings.

The embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### BRIEF DESCRIPTION OF THE FIGURES

The embodiments of the invention that are presented in the sense of examples and their advantages are explained in greater detail below with reference to the accompanying drawings, in which

FIGS. 1a and 1b show block diagrams of arrangements according to embodiments of the invention for presenting visual information,

FIGS. 2a and 2b illustrate operation of an advertising kiosk that comprises an arrangement according to an embodiment of the invention for presenting visual information,

FIG. 3 shows a block diagram of a device according to an embodiment of the invention for presenting visual information,

FIG. 4 shows a desktop communication device that comprises an arrangement according to an embodiment of the invention for presenting visual information,

FIGS. 5a and 5b illustrate operation of a communication device that comprises an arrangement according to an embodiment of the invention for presenting visual information, and

FIG. 6 is a flow chart of a method according to an embodiment of the invention for presenting visual information.

### DETAILED DESCRIPTION OF THE EMBODIMENTS

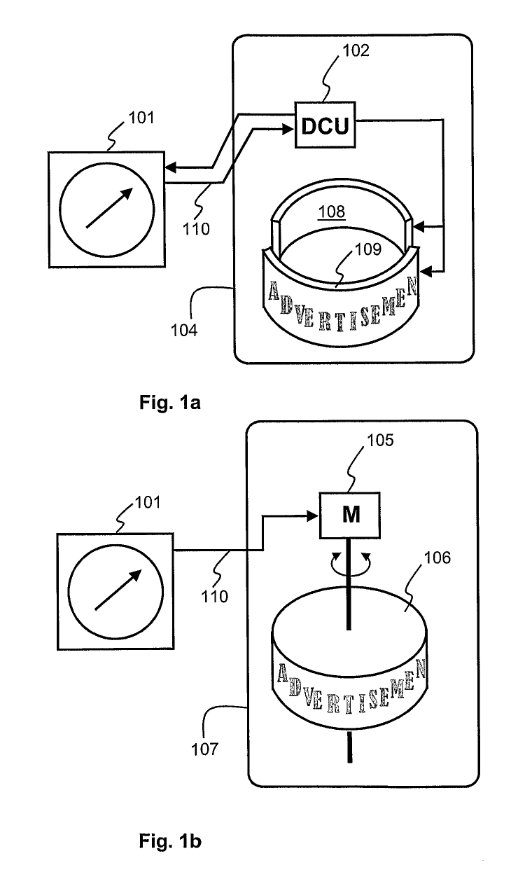

FIG. 1a shows a block diagram of an arrangement according to an embodiment of the invention for presenting visual information. The arrangement comprises a direction detector 101 arranged to find a direction in which a potential observer is situated in the surroundings of the direction detector and a display unit 104 one or more surfaces of which are arranged to present the visual information in a graphical form and/or in a written form (text). The direction detector 101 is arranged to generate a direction detection result 110 that is an indicator of the direction in which the potential observer is situated. The display unit 104 is responsive to the direction detection result 110. In the example situation shown in FIG. 1a, the display unit 104 displays a text “ADVERTISEMENT”. The display unit 104 comprises two electrical display elements 108, 109 and a display control unit 102 that is arranged to operate the electrical display elements responsive to the direction detection result 110.

The display unit 104 is capable of showing the visual information towards different directions, because surfaces of the display elements 108 and 109 have a curved shape. It should be, however, noted that the display unit 104 can as well be made capable of showing the visual information towards different directions by using a plurality of flat display screens facing towards different directions. The display unit 104 is arranged to show the visual information towards a direction that corresponds with the direction detection result 110 and to change the direction towards which the visual information is shown as a response to a situation in which the direction detection result 110 is changing.

In an arrangement according to an embodiment of the invention the direction detector 101 is arranged to search the direction, in which the potential observer is situated, from a range between zero and 360 degrees.

In an arrangement according to an embodiment of the invention the direction detection result 110 is arranged to indicate the direction, in which the potential observer is situated, with a pre-determined resolution. The resolution can be e.g. 90 degrees, 45 degrees, 30 degrees, or 15 degrees. In this document a resolution of angle α means that the direction detection result 110 is able to indicate the direction, in which the potential observer is situated, with an accuracy of ±α/2.

In an arrangement according to an embodiment of the invention the direction detector 101 comprises a rotatable directional microphone and a control processor that is arranged to rotate the directional microphone and to determine the direction detection result 110 as a direction that corresponds with a maximum output signal of the rotatable directional microphone. In other words, the direction detector 101 finds a direction from which a strongest voice/signal can be received. The rotatable directional microphone can be arranged to be rotatable both in horizontal and vertical directions.

In an arrangement according to an embodiment of the invention the direction detector 101 comprises at least two microphones and a control processor that is arranged to determine the direction detection result 110 on the basis of a phase shift and/or amplitude difference between output signals of the at least two microphones. The direction detection result 110 can be e.g. a direction in which the phase shift and/or the amplitude difference is minimized.

In an arrangement according to an embodiment of the invention the direction detector 101 comprises one or more microphones, a laser based distance detector, and a control processor that is arranged to determine a pre-determined number of candidate values for the direction detection result 110 on the basis of acoustical signals received in the direction detector. As described above, it is possible to use, for example, a rotatable directional microphone and/or at least two microphones. The control processor is further arranged to measure, with the laser based distance detector, physical distances between the direction detector and physical objects located in directions corresponding with the candidate values, and to select that candidate value that corresponds with the shortest physical distance to be the final direction detection result 110.

In practical situations it is possible that there are two or more potential observers in such a way that a potential observer that is farther from the direction detector 101 may emit a stronger voice than another potential observer that is nearer to the direction detector 101. In the situations of the kind described above, the one or more microphones are used for determining the directions in which the two or more potential observers are located in the surroundings of the direction detector and the physical distances measured with the laser based distance detector have a decisive role in determining the final direction detection result 110.

In an arrangement according to an embodiment of the invention the direction detector comprises 101 a rotatable directional photo sensor and a control processor that is arranged to rotate the directional photo sensor and to determine the direction detection result 110 as a direction that corresponds with a maximum variation of an output signal of the rotatable directional photo sensor. In other words, the direction detector 101 can act as a directional motion detector that is arranged to find a direction from which a strongest variation of light can be received. In this case the direction detection result 110 indicates a direction in which there is most activity in the surroundings of the direction detector. This kind of direction detector can be used, for example, in an advertising kiosk that is arranged to show the most significant part of the visual information towards a direction in which a significant portion of people in the surroundings of the advertising kiosk is located.

In an arrangement according to an embodiment of the invention the direction detector comprises 101 at least two directional photo sensors and a control processor that is arranged to determine the direction detection result 110 on the basis of variations of output signals of the at least two directional photo sensors. The direction detection result 110 can be, for example, a direction that corresponds with a weighted average of vectors representing the main reception directions of the at least two directional photo sensors, wherein strengths of variation of the output signals of the at least two directional photo sensors are used as respective weighting factors in the above-mentioned weighted average. In other words, the direction detector 101 can act as a directional motion detector that is arranged to find a direction from which a strongest variation of light can be received.

In an arrangement according to an embodiment of the invention the direction detector 101 comprises a radar device and a control processor that is arranged to determine the direction detection result 110 as a direction that corresponds with a reflected radar signal indicating strongest motion of physical objects.

In an arrangement according to an embodiment of the invention the direction detector 101 comprises a sonar device and a control processor that is arranged to determine the direction detection result 110 as a direction that corresponds with a reflected sonar signal indicating strongest motion of physical objects.

In an arrangement according to an embodiment of the invention the direction detector 101 comprises an infrared transmitter and receiver and a control processor that is arranged to determine the direction detection result 110 as a direction that corresponds with a reflected infrared signal indicating strongest motion of physical objects.

FIG. 1b shows a block diagram of an arrangement according to an embodiment of the invention for presenting visual information. The arrangement comprises a direction detector 101 arranged to find a direction in which a potential observer is situated in the surroundings of the direction detector and a display unit 107 arranged to present the visual information in a graphical form and/or in a written form (text). The direction detector 101 is arranged to generate a direction detection result 110 that is an indicator of the direction in which the potential observer is situated. The display unit 107 is responsive to the direction detection result 110. The display unit 107 comprises a mechanically movable part 106 and a motion generation element 105 that is arranged to move the mechanically movable part responsive to the direction detection result 110. A surface of the mechanically movable part 106 is arranged to present the visual information. In the example situation shown in FIG. 1b, the display unit 107 displays a text “ADVERTISEMENT”. In the embodiment shown in FIG. 1b the mechanically movable part 106 is rotated according to the direction detection result 110. It is also possible to use a motion generation element that makes a linear motion responsive to the direction detection result 110.

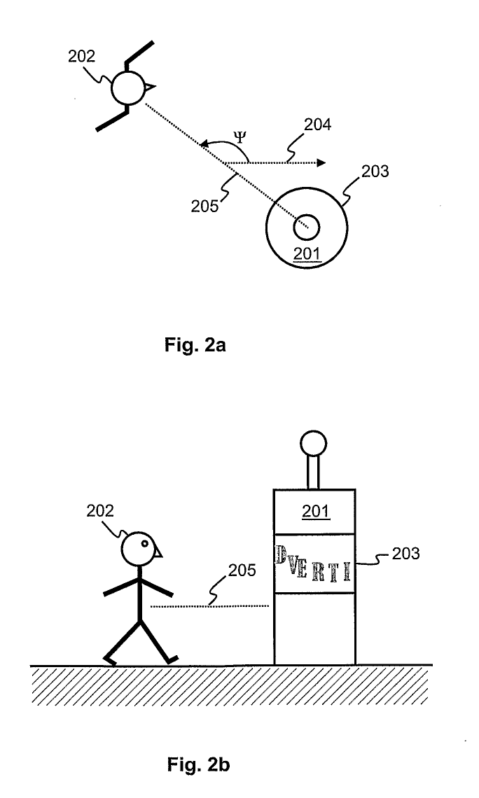

FIGS. 2a and 2b illustrate operation of an advertising kiosk 201 that comprises an arrangement according to an embodiment of the invention for presenting visual information. FIG. 2a shows a bird's eye view of an example situation and FIG. 2b shows a side-view of the same example situation. The advertising kiosk 201 finds a direction in which a potential observer, e.g. a passer-by 202, is situated in the surroundings of the advertising kiosk. A direction detection result can be expressed as e.g. an angle Ψ between a pre-determined horizontal reference direction 204 and a horizontal spatial line 205 from the advertising kiosk to the passer-by. A display unit 203 of the advertising kiosk is controlled according to the direction detection result Ψ. The display unit can be controlled, for example, in such a way that the most informative part of visual information displayed by the display unit is arranged to face towards the passer-by 202. The display unit 203 shows visual information on a curved surface that extends around the advertising kiosk 201. It should be, however, noted that the display unit could as well comprise a plurality of flat display screens facing towards different directions.

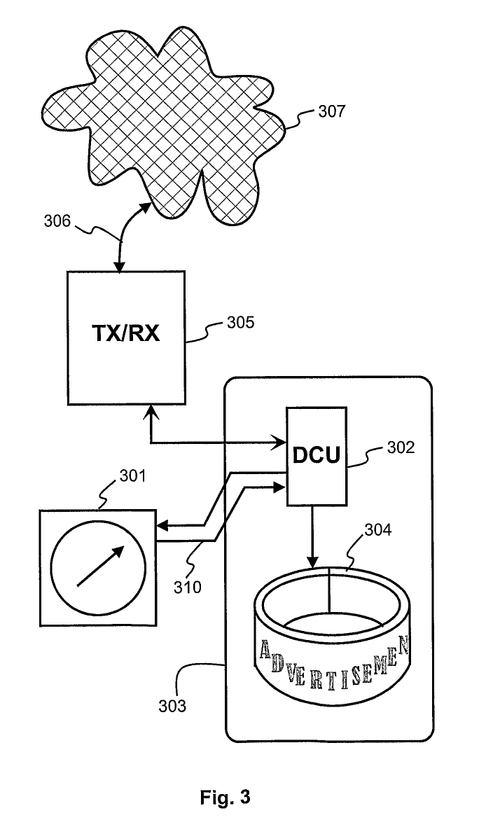

FIG. 3 shows a block diagram of a device according to an embodiment of the invention for presenting visual information. The device comprises a direction detector 301 arranged to find a direction in which a potential observer is situated in the surroundings of the direction detector and a display unit 303 arranged to present the visual information in a graphical form and/or in a written form (text). The direction detector 301 is arranged to generate a direction detection result 310 that is an indicator of the direction in which the potential observer is situated. The display unit is responsive to the direction detection result 310. The display unit 303 comprises a flexible electrical display element 304 that has been, in this example, bent to form a ring and a display control unit 302 that is arranged to operate the electrical display element 304 responsive to the direction detection result 310. It is also possible that the display unit 303 comprises only one flat electrical display element or a plurality of flat or curved electrical display elements facing towards different directions. It is also possible that the display unit 303 comprises a mechanically movable part and a motion generation element arranged to move the mechanically movable part responsive to the direction detection result. The mechanically movable part can comprise an electrical display screen that is fixed on the surface of the mechanically movable part. It is also possible that at least a part of a surface of the mechanically movable part is covered with one or more electrical display element. It is also possible that the display unit 303 comprises an electrical display element a display surface of which has a spherical or conical shape.

The display unit 303 is capable of showing the visual information towards different directions, because surface of the display element 304 has a curved shape. It should be, however, noted that the display unit 303 can as well be made capable of showing the visual information towards different directions by using a plurality of flat display screens facing towards different directions. The display unit 303 is arranged to show the visual information towards a direction that corresponds with the direction detection result 310 and to change the direction towards which the visual information is shown as a response to a situation in which the direction detection result 310 is changing.

A device according to an embodiment of the invention comprises a communication element 305 that is arranged to transmit information to an electrical communication channel 306 and to receive information from the electrical communication channel 306. The communication element 305 can comprise for example one or more of the following: a radio transceiver, a corded link transceiver, and an infrared transceiver. The communication element 305 can be arranged to connect the device to at least one of the following: a public wire line telephone network, a cellular mobile telephone network, a wire line local area network, a wireless local area network (WLAN), a wireless personal area network (WPAN), a wireless regional area network (WRAN), and Wimax (Worldwide Interoperability for Microwave Access). In FIG. 3, a cross-hatched cloud 307 represents communication networks to which the device can be connected.

In a device according to an embodiment of the invention the communication element is arranged to support at least one cellular radio communication mechanism. Each of the at least one cellular radio communication mechanism can be any of the following: GSM (Global System Mobile), 3G (3^{rd} generation mobile communication system), GPRS (General Packet Radio System), EGPRS (Enhanced General Packet Radio System), LTE (Long Term Evolution), and HSPA (High Speed Packet Access).

In a device according to an embodiment of the invention the communication element is arranged to support a wireless communication mechanism that can be e.g. the Bluetooth®, the ZigBee, the Wibree, DECT (Digital Enhanced Cordless Communication), and/or UWB (Ultra-Wideband).

A device according to an embodiment of the invention is a desktop communication device.

In a device according to an embodiment of the invention the flexible electrical display element 304 is wrapped on a body of the device. The flexible electrical display element 304 can be arranged to extend around the body of the device in order to provide a viewing angle of 360 degrees.

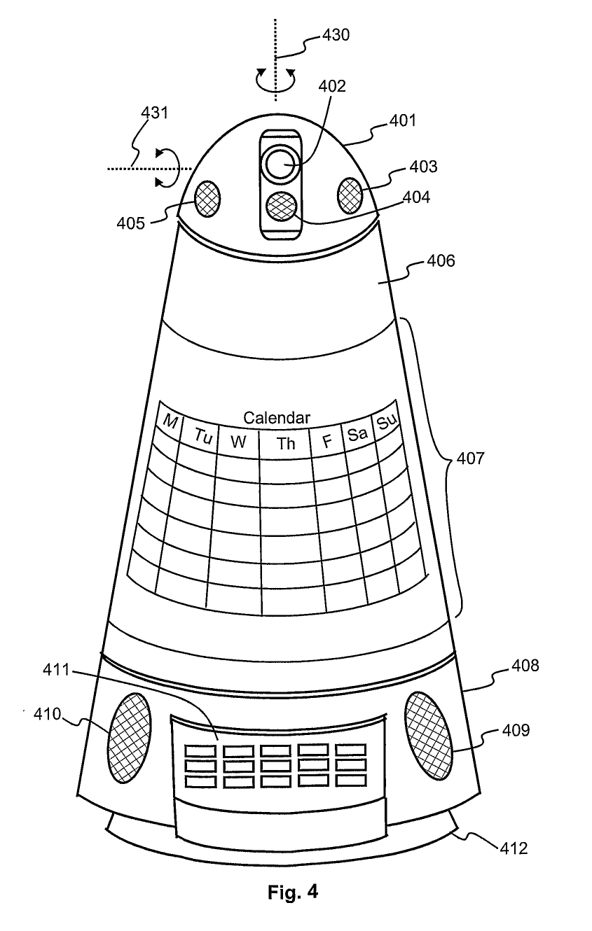

FIG. 4 shows a communication device that comprises an arrangement according to an embodiment of the invention for presenting visual information. The communication device comprises a communication element that is arranged to transmit information to an electrical communication channel and to receive information from the electrical communication channel. The communication device comprises a direction detector arranged to find a direction in which a potential observer, e.g. a user of the communication device, is situated in the surroundings of the direction detector and to generate a direction detection result that is an indicator of the direction in which the user is situated. The communication device comprises a first part, i.e. a top part, 401 comprising a camera module 402 and at least one microphone 403-405. The direction detector is preferably located in the top part 401. The communication device comprises a second part, i.e. a middle part, 406 comprising an electrical display element 407 that is wrapped around the middle part. It is also possible to use two or more electrical display elements on the surface of the middle part 406. The communication device comprises a display control unit arranged to control the electrical display element 407 according to the direction detection result produced with the direction detector. In the example situation shown in FIG. 4, the electrical display element 407 shows a calendar. The communication device comprises a third part, i.e. a bottom part, 408 comprising at least one speaker element 409, 410 and at least one of the following: a retractable keyboard and a retractable electronic drawing pad. FIG. 4 shows a retractable keyboard 411 that is in the pulled-out position. The top part 401 is rotatable with respect to the middle part 406 around a first spatial axis 430 and the bottom part 408 is rotatable with respect to the middle part 406 around the first spatial axis. The communication device comprises a base element 412 that is arranged to support the communication device in such a way that the bottom part 408 is able to rotate around the first spatial axis 430 with respect to a surface on which the communication device is located. Therefore, horizontal rotational positions of the top part 401 and the bottom part 408 are adjustable with respect to the surface on which the communication device is located.

In the communication device shown in FIG. 4, the middle part 406 and the bottom part 408 form a truncated cone. The conical shape is advantageous, for example, when the communication device is used as a desktop communication device.

In a communication device according to an embodiment of the invention the direction detector is arranged to search the direction, in which the potential observer is situated, from a range between zero and 360 degrees and the direction detection result is arranged to indicate the direction, in which the potential observer is situated, with a pre-determined resolution. The resolution can be e.g. 90 degrees, 45 degrees, 30 degrees, or 15 degrees.

In a communication device according to an embodiment of the invention the display control unit is arranged to make the electrical display element to show, on a side of the middle part 406 that faces towards a direction opposite to the direction detection result, an image that is a mirrored version of a main image shown on a side of the middle part that faces towards the direction of said direction detection result. Therefore, people other than the main user of the communication device can follow what happens. Texts that are shown on the side of the middle part 406 that faces towards the direction opposite to the direction detection result are preferably not mirrored.

A communication device according to an embodiment of the invention comprises a projector device arranged project the main image to one or more vertical surfaces so that the other people can watch it.

In a communication device according to an embodiment of the invention the camera module 402 is rotatable with respect to the top part 401 around a second spatial axis 431 a direction of which deviates from a direction of the first spatial axis 430. In other words, a vertical rotational position (an inclination angle) of the camera module can be altered. The camera module 402 can be supported to the top part 401 for example with a needle suspension system. The communication device preferably comprises a camera control unit that is arranged to turn the camera module towards a direction that corresponds with the direction detection result. An output signal of the microphone 401 that is mounted on the camera module can be used for controlling the vertical rotational position of the camera module.

In a communication device according to an embodiment of the invention the top part 401 is rotatable with respect to the middle part 406 around the second spatial axis 431. In this case, the vertical rotational position of the camera module 402 can be altered even if the camera module were rigidly mounted on the top part 401.

A communication device according to an embodiment of the invention is arranged to transmit an image captured by the camera module 402 to at least one of the following: a public wire line telephone network, a cellular mobile telephone network, a wire line local area network, and a wireless local area network.

In a communication device according to an embodiment of the invention the middle part 406 comprises a magnetic coil system that is arranged to support the top part 401 with the aid of magnetic fields. The top part 401 may contain one or more permanent magnets that produce a repulsive force with respect to the above-mentioned magnetic coil system. Orientation of the top part can be controlled by adjusting the electrical currents flowing in the magnetic coil system. It is also possible that the one or more permanent magnets are located in the middle part 406 and the coil system is located in the top part 401.

A communication device according to an embodiment of the invention comprises a motion generating unit that is arranged to rotate the top part 401 and the bottom part 408 with respect to the middle part 406 according to the direction detection result. The horizontal and vertical rotational positions of the camera module 402 are oriented according to the direction detection result. The horizontal rotational position of the retractable keyboard 411 and/or the retractable electronic drawing pad is preferably made to be substantially equal to the horizontal rotational position of the camera module.

In a communication device according to an embodiment of the invention the direction detector comprises a speech recognition module capable of being trained to recognize a voice of the user of the communication device. The direction detector is arranged to determine the direction detection result as an arrival direction of the voice of the user.

In a communication device according to an embodiment of the invention the direction detector comprises an image recognition module capable of being trained to recognize an outlook of the user of the communication device and the direction detector is arranged to determine said direction detection result as a direction from which an image that matches best with the outlook of the user can be captured.

The communication device shown in FIG. 4 can be used as e.g. a family communication hub with the aid of which family related actions can be performed. The communication device may comprise hardware and/or software that enable each family member to use the communication device for individual actions and also for actions concerning two or more family members. The communication device can replace a paper calendar and/or yellow stickers that are usually used for communicating and sharing tasks between the family members. The communication device can comprise hardware and/or software that enable the communication device to send information to e.g. mobile phones of family members according to a pre-determined time schedule. For example, a mother can configure the communication device to send a shopping list to a father at a time instant when a workday of the father is about ending. If the shopping list were sent to the father too early, he would probably forget to whole shopping issue before the end of the workday. Therefore, with the aid of the communication device, synchronization of information between different family members can be accomplished in a flexible way and in a right time. For a skilled person it is obvious that there is a countless amount of different applications the communication device shown in FIG. 4 can be used for.

The electrical display element 407 can be arranged to show a decorative image as a response to a situation in which the communication device in a passive mode, i.e. nobody is using the communication device. The decorative image can be, for example, a picture illustrating a turbulent flow, a picture presenting a fractal, or a picture presenting a beautiful landscape. Therefore, the communication element can also act as a decorative element.

The communication device can be provided with such hardware and/or software that the communication device can be waked up from its passive mode using touch screen or voice commands. The communication device can be provided with such hardware and/or software that the communication device can identify a user by name and/or voice analysis and define the identified user to be a key user. The communication device can be provided with hardware and/or software that is/are able to combine the wake-up touch command with finger print recognition. The orientation of the camera module can be controlled by voice and/or image recognition mechanisms. The camera module 402 orients to the key user and orientation of the retractable keyboard and/or the retractable electronic drawing pad follows. After wake-up the communication device is ready to be used as a family connectivity centre.

The communication device can be provided with such hardware and/or software that it can be controlled with voice commands and/or with the retractable keyboard 411 and/or with the retractable electronic drawing pad and a character recognition algorithm. The communication device can be provided with such hardware and/or software that the key user determines the front of the system, i.e. the direction detection result, in order to prevent the communication device from switching endlessly between various users or other people that take part in a conversation. The communication device can be provided with such hardware and/or software that the orientation of the camera module follows the key user only when the key user stays at a new position for a certain time. This makes the movements of the camera module smoother in a situation in which the key user changes rapidly his/her position around the communication device. The communication device can be provided with such hardware and/or software that the position and adjustments of the camera module can controlled using verbal commands such as “follow me”, “focus on John” etc.

The communication device can be provided with such hardware and/or software that the electrical display element 407 gives a full or limited access to the content of family members. For example, one can check the calendar of one or several family members in order to make appointments, place shopping requests, etc. The communication device can be provided with such hardware and/or software that the electrical display element 411 can also operate in a video conference mode.

The communication device can be provided with such hardware and/or software that visual information shown with the electrical display element 402 can be fully personalized. One instance could be a calendar area, task area, and icons for phone/video calls and for multimedia services (MMS). For example, a drag-and-drop action can initiate an operation related to those icons.

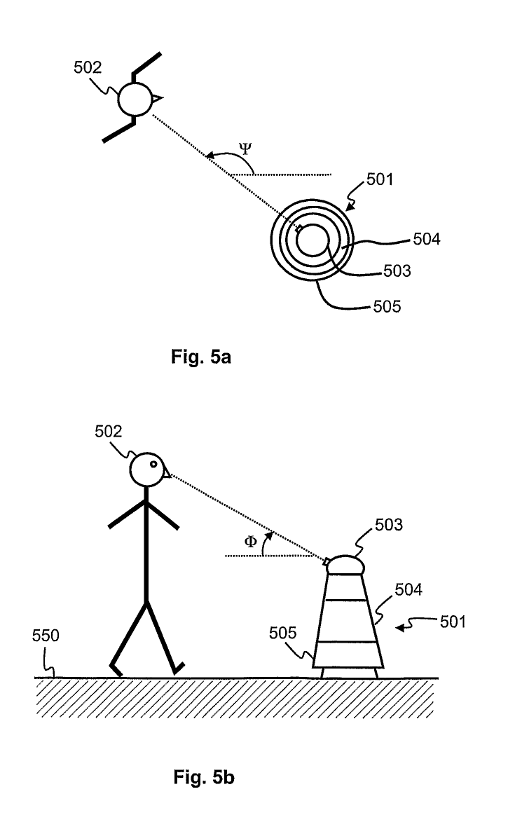

FIGS. 5a and 5b illustrate operation of a communication device that comprises an arrangement according to an embodiment of the invention for presenting visual information. FIG. 5a shows a bird's eye view of an example situation and FIG. 5b shows a side-view of the same example situation. The communication device 501 generated a direction detection result by finding a direction in which a user 502 is situated in the surroundings of the communication device. The direction detection result can be expressed with angle Ψ that is shown in FIG. 5a. An electrical display element 504 of the communication device 501 can be controlled according to angle Ψ.

The communication device 501 can be equipped with a bottom part 505 that is rotatable with respect to a surface 550 on which the communication device is located. A horizontal rotational position of the bottom part 505 can be controlled according to angle Ψ.

The communication device 501 can be equipped with a camera module that is preferably located in a top part 503 of the communication device. In addition to the above-mentioned angle Ψ, the direction detection result can be expressed also with angle Φ that is shown in FIG. 5b. A horizontal rotational position of the camera module can be controlled according to angle Ψ and a vertical rotational position of the camera module can be controlled according to angle Φ.

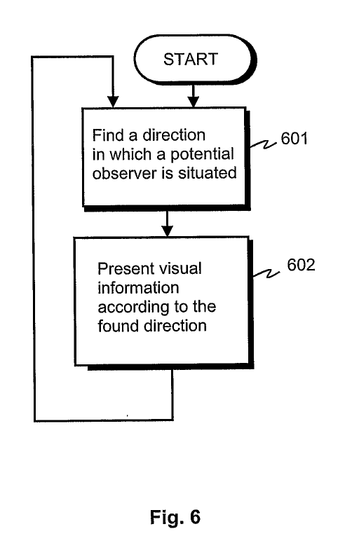

FIG. 6 shows a flow chart of a method according to an embodiment of the invention for presenting visual information. In the method, a direction detection result is generated by finding 601 a direction in which a potential observer is situated in the surroundings of a direction detector, and visual information in a graphical form and/or in a written form (text) is presented 602 responsive to the direction detection result. The direction detection result is an indicator of the direction, in which the potential observer is situated. In the phase 602, the visual information is shown towards a direction that corresponds with the direction detection result and the direction towards which the visual information is shown is changed as a response to a situation in which the direction detection result is changing.

In a method according to an embodiment of the invention the direction, in which the potential observer is situated, is searched from a range between zero and 360 degrees.

In a method according to an embodiment of the invention the visual information is presented by controlling operation of at least one electrical display element on the basis of said direction detection result.

In a method according to an embodiment of the invention the visual information is presented by controlling a position of a mechanically movable part a surface of which is arranged to present the visual information.

In a method according to an embodiment of the invention the direction detection result is a direction that corresponds with a maximum output signal of a rotatable directional microphone.

In a method according to an embodiment of the invention the direction detection result is determined on the basis of a phase shift between output signals of at least two microphones.

In a method according to an embodiment of the invention the direction detection result is a direction that corresponds with a maximum variation of an output signal of a rotatable directional photo sensor.

In a method according to an embodiment of the invention the direction detection result is determined on the basis of variations of output signals of at least two directional photo sensors. The direction detection result can be, for example, a direction that corresponds with a weighted average of vectors representing the main reception directions of the at least two directional photo sensors, wherein strengths of variation of the output signals of the at least two directional photo sensors are used as respective weighting factors in the above-mentioned weighted average.

In a method according to an embodiment of the invention the direction detection result is obtained by using a speech recognition module that has been trained to recognize a voice of a person and by determining the direction detection result as an arrival direction of the voice of the person.

In a method according to an embodiment of the invention the direction detection result is obtained by using an image recognition module that has been trained to recognize an outlook of a person and by determining the direction detection result as a direction from which an image that matches best with the outlook of the person can be captured.

In a method according to an embodiment of the invention a position of a camera module is controlled according to the direction detection result and an image captured by the camera module is transmitted to at least one of the following: a public wire line telephone network, a cellular mobile telephone network, a wire line local area network, a wireless local area network (WLAN), a wireless personal area network (WPAN), a wireless regional area network (WRAN), and Wimax (Worldwide Interoperability for Microwave Access).

In a method according to an embodiment of the invention a position of an input unit is controlled according to said direction detection result. The input unit can comprise at least one of the following: a retractable keyboard and a retractable electronic drawing pad.

A device comprising a direction detector and a display unit capable of showing visual information towards different directions in a graphical form and/or in a written form can also comprise a programmable processor that is arranged to control the direction detector and the display unit with the aid of a computer program product according to an embodiment of the invention. The computer program product according to an embodiment of the invention comprises:
computer program means for making the direction detector to find a direction in which a potential observer is situated in the surroundings of the direction detector and to generate a direction detection result that is an indicator of the direction in which the potential observer is situated, and
computer program means for making the display unit to show the visual information towards a direction that corresponds with the direction detection result and to change the direction towards which the visual information is shown as a response to a situation in which the direction detection result is changing, the visual information being shown in at least one of the following forms: a graphical form and a written form.

The computer program means can be, for example, sub-routines and/or functions.

A computer program product according to an embodiment of the invention can be embodied in a computer readable medium. The computer readable medium can be, for example, an optical compact disk or an electronic memory device like a RAM (random access memory) or a ROM (read only memory).

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the independent claims appended hereto. The specific examples provided in the description given above should not be construed as limiting. Therefore, the invention is not limited merely to the embodiments described above, many variants being possible without departing from the scope of the inventive idea defined in the independent claims.

What is claimed is:

1. An arrangement for presenting visual information, the arrangement comprising:
a direction detector arranged to find a direction in which a potential observer is situated in the surroundings of the direction detector and to generate a direction detection result that is an indicator of said direction in which the potential observer is situated, and
a display unit capable of showing the visual information towards different directions in at least one of the following forms: a graphical form and a written form,
wherein the display unit is arranged to show the visual information towards a direction that corresponds with the direction detection result and to change the direction towards which the visual information is shown as a response to a situation in which the direction detection result is changing.

2. An arrangement according to claim 1, wherein the display unit comprises at least one electrical display element and a display control unit arranged to operate the at least one electrical display element responsive to said direction detection result.

3. An arrangement according to claim 1, wherein the display unit comprises a mechanically movable part and a motion generation element arranged to move said mechanically movable part responsive to said direction detection result, a surface of the mechanically movable part being arranged to present the visual information.

4. An arrangement according to claim 1, wherein the direction detector comprises a rotatable directional microphone and a control processor arranged to rotate the directional microphone and to determine said direction detection result as a direction that corresponds with a maximum output signal of the rotatable directional microphone.

5. An arrangement according to claim 1, wherein the direction detector comprises at least two microphones and a control processor arranged to determine said direction detection result on the basis of at least one of the following: a phase shift between output signals of the at least two microphones and an amplitude difference between the output signals of the at least two microphones.

6. An arrangement according to claim 1, wherein the direction detector comprises a rotatable directional photo sensor and a control processor arranged to rotate the directional photo sensor and to determine said direction detection result as a direction that corresponds with a maximum variation of an output signal of the rotatable directional photo sensor.

7. An arrangement according to claim 1, wherein the direction detector comprises at least two directional photo sensors and a control processor arranged to determine said direction detection result on the basis of variations of output signals of the at least two directional photo sensors.

8. An arrangement according to claim 4, wherein the direction detector comprises a laser based distance detector and the control processor is arranged:
to determine a pre-determined number of candidate values for said direction detection result on the basis of acoustical signals received in the direction detector,
to measure, with the laser based distance detector, physical distances between the direction detector and physical objects located in directions corresponding with the candidate values, and
to select that candidate value that corresponds with the shortest physical distance to be said direction detection result.

9. A device for presenting visual information, the device comprising:
a direction detector arranged to find a direction in which a potential observer is situated in the surroundings of the direction detector and to generate a direction detection result that is an indicator of said direction in which the potential observer is situated, and
a display unit capable of showing the visual information towards different directions in at least one of the following forms: a graphical form and a written form,
wherein the display unit is arranged to show the visual information towards a direction that corresponds with the direction detection result and to change the direction towards which the visual information is shown as a response to a situation in which the direction detection result is changing.

10. A device according to claim 9, wherein the display unit comprises at least one electrical display element and a display control unit arranged to operate the at least one electrical display element responsive to said direction detection result.

11. A device according to claim 9, wherein the display unit comprises a mechanically movable part and a motion generation element arranged to move said mechanically movable part responsive to said direction detection result, a surface of the mechanically movable part being arranged to present the visual information.

12. A device according to claim 10, wherein the device comprises a communication element arranged to transmit information to an electrical communication channel and to receive information from the electrical communication channel, the communication element comprising at least one of the following: a radio transceiver, a corded link transceiver, and an infrared transceiver.

13. A device according to claim 12, wherein the communication element is arranged to connect the device to at least one of the following: a public wire line telephone network, a cellular mobile telephone network, a wire line local area network, a wireless local area network (WLAN), a wireless personal area network (WPAN), a wireless regional area network (WRAN), and Wimax (Worldwide Interoperability for Microwave Access).

14. A device according to claim 12, wherein the communication element is arranged to support at least one cellular radio communication mechanism.

15. A device according to claim 12, wherein the device comprises:
a first part comprising a camera module and at lest one microphone,
a second part comprising the at least one electrical display element, and
a third part comprising a speaker element,
whereby the first part is rotatable with respect to the second part around a first spatial axis and the third part is rotatable with respect to the second part around the first spatial axis.

16. A device according to claim 15, wherein the camera module is rotatable with respect to the first part around a second spatial axis, a direction of the spatial second axis deviating from a direction of the first spatial axis.

17. A device according to claim 15, wherein the first part is rotatable with respect to the second part around a second spatial axis, a direction of the second spatial axis deviating from a direction of the first spatial axis.

18. A device according to claim 15, wherein the second part comprises a magnetic coil system arranged to support the first part with the aid of magnetic fields.

19. A device according to claim 15, wherein the device comprises a motion generating unit arranged to rotate the first part and the third part with respect to the second part responsive to said direction detection result.

20. A device according to claim 19, wherein the direction detector comprises one of the following:
a speech recognition module capable of being trained to recognize a voice of a given person,
an image recognition module capable of being trained to recognize an out-look of the given person, and
wherein the direction detector is arranged to determine said direction detection result as one of the following:
an arrival direction of the voice of the given person,
a direction from which an image that matches best with the outlook of the given person can be captured.

21-43. (canceled)
